(19) United States
(12) Patent Application Publication
(10) Pub. No.: US 2008/0029283 A1
(43) Pub. Date: Feb. 7, 2008

(54) Hand-held power tool with pneumatic percussion mechanism

(75) Inventor: Stefan Hammerstingl, Munich (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/888,131

(22) Filed: Jul. 30, 2007

(30) Foreign Application Priority Data
Aug. 7, 2006 (DE) 10 2006 000 395.0

(51) Int. Cl. B25D 9/04

(52) U.S. Cl. 173/132

(57) ABSTRACT

A hand-held power tool for percussively driving a working tool (3) includes a percussion mechanism (4) having a guide tube (5), in which a percussion piston (7) which is driven by an air spring (6), is axially displaceable for applying axial impacts to an anvil (8) that applies axial blows to the working tool (3), and a viscoelastic damping member (9) arranged in the guide tube (5) and engaging in a circumferential radial groove (13) of the anvil (8) and which is axially limited at opposite sides thereof.

### BACKGROUND OF THE INVENTION

1. Field of the Invention

The present invention relates to a percussion hand-held power tool with a pneumatic percussion mechanism such as, e.g., chisel hammer or hammer drill.

2. Description of the Prior Art

A percussion mechanism of a percussion hand-held power tool includes a percussion piston, which is displaceable in a guide tube and is driven by an air spring and which applies axial blows to an axially displaceable, within certain limits, anvil that itself imparts blows to an end surface of an axially displaceable, also within certain limits, working tool.

At extreme operational conditions, as with working tool-side directed, idle blows, with the working tool being lifted off a constructional component, or at reflected backward, oppositely directed, hammer blows upon encountering reinforcement, the percussion mechanism is not any more in an optimal operational condition and generates increased vibrations which must be damped.

European Publication EP-0014760 and International Publication WO 03024671 disclose a percussion hand-held power tool the pneumatic percussion mechanism of which includes a damping member that damps both the idle blow of the percussion piston and the hammer blow of the anvil. In the hand-held power tool disclosed in WO 03024671, the percussion piston has an axially upset, by a tapering section, outer profile that frictionally penetrates in a radially narrowing steel ring, dissipating, at an idle blow, over an elongate axial damping region, a major part of the motion energy of the percussion piston in the damping member.

An object of the present invention is to provide a damping member suitable for damping both the idle blow of the percussion piston and the hammer blow of the anvil.

### SUMMARY OF THE INVENTION

This and other objects of the present invention, which will become apparent hereinafter, are achieved by providing a hand-held power tool for percussively driving a working tool and including an anvil for applying blows to the working tool and axially displaceable within certain limits, a percussion mechanism for axially impacting the anvil and having a guide tube, a reciprocating percussion piston for applying impacts to the anvil, an air spring for driving the percussion piston, and a viscoelastic damping member arranged in the guide tube and engaging in a circumferential radial groove of the anvil and axially limited at opposite sides thereof.

The circumferential radial groove, which is axially limited at its opposite ends, elastically axially limits the displacement of the anvil at the end operational positions, dissipating its motion energy in the damping member. Thus, one and the same damping member adequately damps both the idle blow and the hammer blow of the anvil.

Advantageously, the axial length of the radial groove of the anvil lies in a range from a half of a diameter of the anvil to a double of the anvil diameter. Thus, the damping member does not limit the displacement of the anvil at normal operational conditions.

Preferably, the damping member is formed as an annulus, advantageously as an O-ring within an annular thickness lying in a range from a quarter to a third of the anvil diameter. Thereby, rotationally symmetrical standardized components with sufficiently large dissipation volume can be used.

Advantageously, the damping member is arranged with its radially outer portion in a radially inner groove formed in the guide tube of the percussion mechanism, and is supported axially by an annular disc. A major part of the damping member is arranged in the radial region of the guide tube, so that the anvil is reduced only insignificantly in the axial region of the radial groove. Thereby, the acoustic impedance of the anvil is not substantially changed at the axial edge of the radial groove, so that practically no reflections of shock waves are produced.

Advantageously, the damping member is formed of a fluoroelastomer such as vinylidene-fluoride-hexafluoropropylene (VF2/BFP), which permits to produce a high war-resistant and high temperature resistant damping member.

The novel features of the present invention which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side, partially cross-sectional view of a hand-held power tool according to the present invention; and

FIG. 2 a longitudinal cross sectional view of the percussion mechanism of the power tool shown in FIG. 1.

### DETAILED DESCRIPTION OF THE PREFERRED EMBODIMENT

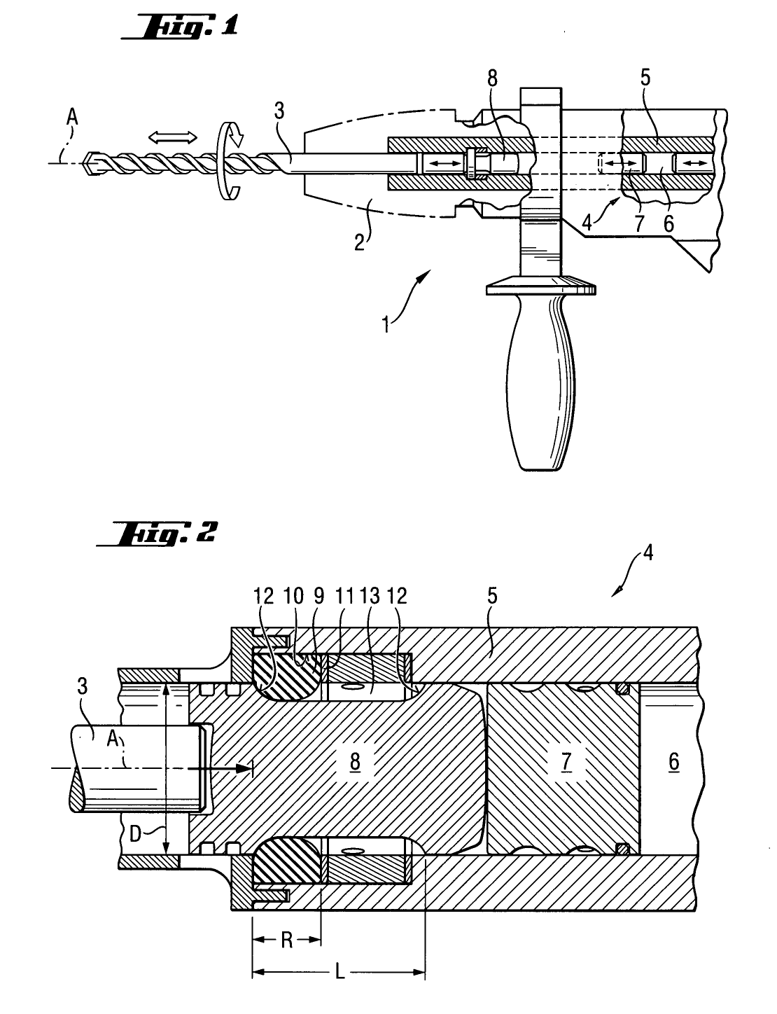

A hand-held power tool 1 according to the present invention and which is partially shown in FIG. 1, drives, rotationally and percussively, a working tool 3 along an axis A. The working tool 3 is received in a chuck 2 of the power tool 1. The working tool 3 is driven by a percussion mechanism 4 that includes a percussion piston 7 displaceable in a guide tube 5 and reciprocatingly driven by an air spring 6. At its working tool side, the percussion piston 7 impacts an anvil 8 which is axially displaceable, within certain limits and which applies axial blows to the working tool 3.

As shown in FIG. 2, a viscoelastic damping member 9, which is formed of vinylidene-fluoride-hexafluoropropylene (VF2/HFP) in form of an O-ring, is arranged with its radially outer portion in a radially inner groove 10 which is formed in the guide tube 5. The damping member 9 is axially supported in the groove 10 with an annular disc 11. The damping member 9 engages, with its annular thickness R that amounts to a quarter of the diameter D of the anvil 9, radially inwardly, in a circumferential radial groove 13 of the anvil 8 and which is axially limited by opposite axial boundaries 12. The axial length L of the groove 13 corresponds to the diameter D of the anvil. In the shown, in FIG. 2, end operational condition of a hammer blow, the displacement of the anvil 8 in the power tool direction is damped, with the working tool-side axial boundary 12 being pressed against the damping member 9, viscoelastically deforming the damping member 9. Thereby, the motion energy of the anvil 8 is dissipated in the damping member 9.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool for percussively driving a working tool (3) and including an anvil (8) for applying blows to the working tool (3) and axially displaceable within certain limits; a percussion mechanism (4) for axially impacting the anvil (8) and having a guide tube (5), a percussion piston (7) for applying impacts to the anvil (8), and an air spring (6) for driving the percussion piston (7) for applying impacts to the anvil (8); and a viscoelastic damping member (9) arranged in the guide tube (5) and engaging in a circumferential radial groove (13) of the anvil (8) and axially limited at opposite sides thereof.

2. A hand-held power tool according to claim 1, wherein an axial length of the radial groove (13) of the anvil (8) lies in a range from a half of a diameter (D0 of the anvil (8) to a double of the anvil diameter (D).

3. A hand-held power tool according to claim 1, wherein the damping member (9) has a shape of an annulus.

4. A hand-held power tool according to claim 1, wherein the guide tube (5) has a radial inner groove (10) into which the damping member (9) engages with a radially outer part thereof.

5. A hand-held power tool according to claim 1, wherein damping member (9) is formed of a fluoroelastomer.
